(19) United States
(12) Patent Application Publication
(10) Pub. No.: US 2007/0140810 A1
(43) Pub. Date: Jun. 21, 2007

(54) Self-locking nut

(76) Inventors: Yuichi Itou, Oita (JP); Yoshihumi Onitake, Oita (JP); Kouki Gotou, Oita (JP)

Correspondence Address: JORDAN AND HAMBURG LLP, 122 EAST 42ND STREET, SUITE 4000, NEW YORK, NY, 10168, US

(21) Appl. No.: 10/593,658

(22) PCT Filed: Mar. 30, 2004
(86) PCT No.: PCT/JP04/04540

§ 371 Date: Oct. 19, 2006

(51) Int. Cl. F16B 37/12; F16B 39/28; F16B 39/22

(52) U.S. Cl. 411/251; 411/291

(57) ABSTRACT

A self-locking nut according to the present invention is a self-locking nut including: a first spring portion; a second spring portion provided in an extended manner continuously from the first spring portion and arranged outside the first spring portion; and a nut body to whose upper end marginal portion the second spring portion is fixed, to be screwed onto a bolt, wherein the first spring portion is provided with a fitting portion that has an inside diameter smaller than an outside diameter of a leg portion of the bolt and is fitted with a thread groove formed on the leg portion of the bolt and a latching portion that is provided in an extended manner continuously from a lower end portion of the fitting portion and is protruded from a circumscribed circle of the leg portion of the bolt, and the second spring portion is constructed so as to be latched with the latching portion when the nut body is rotated in a withdrawal direction at a turning force equal to or more than a predetermined force, whereby the nut is prevented from loosening, and removal of the nut can be easily carried out.

### TECHNICAL FIELD

The present invention relates to a self-locking nut. In detail, it relates to a self-locking nut that prevents a nut screwed onto a bolt from dropping off by an elastic force of a spring.

### BACKGROUND ART

Conventionally, for fixation of structures, a tightening method using a bolt and a nut has been heavily used in every field, and this has been widely used from, for example, steel-reinforced buildings, steel towers, and road installations to automobiles and electric appliances.

For example, as a preventive fitting for preventing a nut from dropping off, a drop-off preventive fitting 101 as shown in FIG. 12(a) is made of an elastic metal or resin or the like, is formed of a tab portion 102 and a coil spring portion 103.

Here, the inside diameter of the coil spring portion is constructed so as to be an inside diameter slightly smaller than the outside diameter of a leg portion of a bolt on which the drop-off preventive fitting is mounted.

When the drop-off preventive fitting is mounted on the leg portion of the bolt, the drop-off preventive fitting is abutted against a front end portion of the bolt screwed into a nut and is rotated in a direction shown by a symbol A in FIG. 12(b).

Namely, by rotating the drop-off preventive fitting while abutting the drop-off preventive fitting against the front end portion of the bolt, a coil spring is deformed in a direction to enlarge the inside diameter of the coil spring portion, and a strand of the coil spring portion is made to fit in along a thread groove provided at the leg portion from an end portion of the leg portion of the bolt so as to mount the drop-off preventive fitting on the leg portion of the bolt.

However, for the drop-off preventive fitting constructed as such, the operation process doubles since the drop-off preventive fitting must be mounted after a tightening operation of the nut, so that the operation is very cumbersome and complicated.

Moreover, the types of bolts and nuts used for steel bridges, steel towers, and the like are not uniform, so that it is necessary to prepare drop-off preventive fittings having inside diameters according to the outside diameters of leg portions of various types of bolts and fit in the same in a manner sandwiching coil springs by means of a dedicated tool, and there is a problem in that it takes a great deal of time to mount and demount the drop-off preventive fittings.

Therefore, as a nut that improves working efficiency by integrating a nut with a drop-off preventive fitting, a self-locking nut 104 as shown in FIGS. 13(a) and (b) disclosed in Japanese Published Unexamined Utility Model Application No. H06-35637 is composed of a nut body 105 and two or more elastic rings 106 fixedly attached to an inner circumferential surface of the nut body 105.

For the ring 106, an engaging piece 107 that protrudes in an inner radial direction is formed at an inner circumferential surface thereof, a spacer 108 is interposed between the rings 106, and the engaging pieces 107 of the rings 106 are engaged with a screw thread 110 of a bolt 109 so as to prevent the screw from loosening.

Consequently, it becomes possible to carry out tightening with a normal tool, however, resistance occurs during rotation since the rings are tightened while being deformed and scrapes away the screw thread of the bolt, and the resistance during a rotation contributes to preventing the nut from loosening and dropping off.

However, the resistance is great and mounting by hand until final tightening is therefore impossible, so that workability cannot be satisfactory.

Moreover, owing to a plastic deformation of the rings, there is a problem of inferiority in reusability relative to a flange nut or the like, and only a frictional resistance resulting from a plastic deformation remains after the nut has loosened, so that there is a risk that the nut may drop off due to vibration or the like for an extended period of time.

Furthermore, since the screw thread of the bolt is scraped away, the bolt is hardly reused under the present situation.

### DISCLOSURE OF THE INVENTION

The present invention has been made in view of the above problems, and an object thereof is to provide a self-locking nut that can prevent the nut from loosening as a result of a strand of a coil spring provided on the nut fitting into a thread groove of a bolt and that is productive in reusability.

In order to achieve the above object, a self-locking nut according to the present invention is a self-locking nut including: a first spring portion; a second spring portion provided in an extended manner continuously from the first spring portion and arranged outside the first spring portion; and a nut body to whose upper end marginal portion the second spring portion is fixed, to be screwed onto a bolt, wherein the first spring portion is provided with a fitting portion that has an inside diameter smaller than an outside diameter of a leg portion of the bolt and is fitted with a thread groove formed on the leg portion of the bolt and a latching portion that is provided in an extended manner continuously from a lower end portion of the fitting portion and is protruded from a circumscribed circle of the leg portion of the bolt, and the second spring portion is constructed so as to be latched with the latching portion when the nut body is rotated in a withdrawal direction at a turning force equal to or more than a predetermined force.

Here, when the nut body is rotated in the withdrawal direction at a turning force equal to or more then the predetermined force, since the inside diameter of the second spring portion is contracted, the lower end of the second spring portion and the latching portion of the first spring portion are latched so as to press-contact with each other, and the turning force in the withdrawing direction applied to the nut body is transmitted to the first spring portion via the second spring portion as a force that acts in a direction to enlarge the strand thereof, it becomes possible to remove the nut.

Namely, during the time that a turning force less than the predetermined force is applied to the nut body, rotation is prevented since the first spring portion is drawn in a direction to contract the inside diameter thereof, and the nut body returns to an original position owing to a restoring force of the second spring portion and does not drop off when the turning force is released, however, by applying a turning force more than the predetermined force to the nut, the second spring portion contracted in diameter and the lower end of the first spring portion are latched, and it becomes possible to remove the nut since the turning force acts on the first spring portion in a direction to enlarge the inside diameter thereof.

### BRIEF DESCRIPTION OF DRAWINGS

FIG. 1 is a schematic perspective view for explaining an example of a self-locking nut to which the present invention has been applied.

FIG. 2 is a sectional explanatory view for explaining a strand construction of the self-locking nut to which the present invention has been applied.

FIGS. 3 are schematic views for showing an example of attachment between a second spring portion and a nut body to which the present invention has been applied.

FIGS. 4 are schematic views for explaining attachment of the self-locking nut to which the present invention has been applied.

FIGS. 5 are schematic views for explaining a tightened condition of the self-locking nut to which the present invention has been applied.

FIGS. 6 are schematic views for explaining a condition where an additional torque has been made to act on a first spring portion after tightening of the self-locking nut to which the present invention has been applied.

FIG. 7 is a schematic perspective view for explaining another example of a first spring portion of a self-locking nut to which the present invention has been applied.

FIGS. 8 are schematic views for explaining a condition where a self-locking nut to which the present invention has been applied is removed.

FIGS. 9 are schematic views for showing an example of a latching means of a first spring portion of a self-locking nut to which the present invention has been applied.

FIGS. 10 are schematic views for showing another example of a latching means of a first spring portion of a self-locking nut to which the present invention has been applied.

FIGS. 11 are schematic views for showing another example of a latching means of a first spring portion of a self-locking nut to which the present invention has been applied.

FIGS. 12 are explanatory views showing an example of a conventional drop-off preventive fitting.

FIGS. 13 are explanatory views for showing an example of a conventional self-locking nut.

### BEST MODE FOR CARRYING OUT THE INVENTION

Hereinafter, an embodiment of the present invention will be described in detail with reference to the drawings for understanding of the present invention.

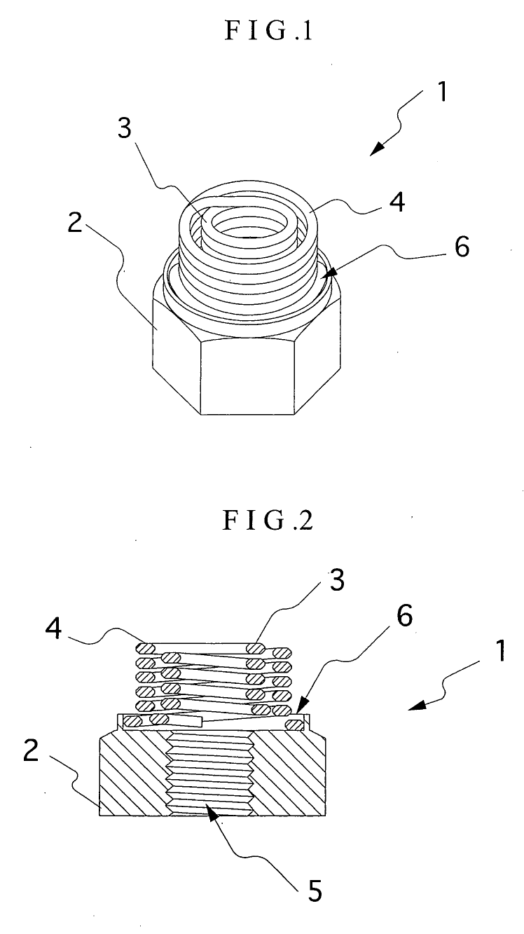

FIG. 1 is a schematic perspective view for explaining an example of a self-locking nut to which the present invention has been applied. FIG. 2 is a sectional explanatory view for explaining a strand construction in FIG. 1. A self-locking nut 1 herein shown is composed of a nut body 2, a first spring portion 3, and a second spring portion 4.

The first spring portion 3 is wound clockwise from a lower end portion toward an upper end portion, and the inside diameter of the first spring portion 3 other than the lower end is formed at a diameter slightly smaller than the outside diameter of a leg portion of a bolt. Moreover, the inside diameter of the lower end of the first spring portion 3 is formed at a diameter slightly greater than the outside diameter of the leg portion of the bolt.

Next, the second spring portion 4 is provided in an extended manner continuously from the first spring portion, and is wound counterclockwise from an upper end portion toward a lower end portion. The lower end of the second spring portion 4 is fixed by coupling to an upper end margin of the nut body 2.

In this connection, the number of windings at the lower end of the first spring portion is not limited to that of the present example, and the number of windings can be any as long as the lower end of the first spring portion can be latched by contraction in the inside diameter of the second spring portion. Furthermore, the number of windings of the first spring portion other than the lower end and the number of windings of the second spring portion are also not limited by those of the present example.

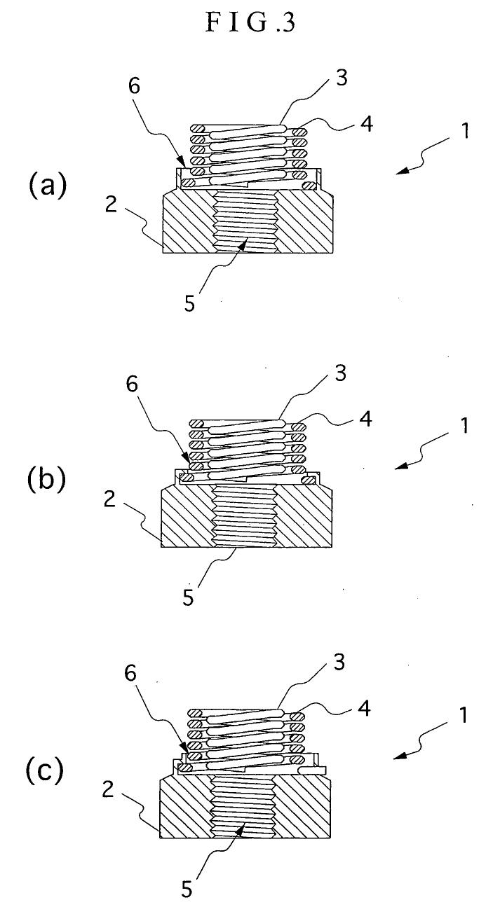

Here, for the nut body 2, a groove portion 6 is provided in a surrounding manner along an upper end circumferential margin of a threaded hole 5 of the nut body 2 as shown in FIG. 3(a). The second spring portion 4 is coupled by fitting a strand, the lower end of the second spring portion 4, into the groove portion 6 and crimping the entire circumference of the groove portion 6 having a circular form as shown in FIG. 3(b). In addition, the second spring portion 4 may be coupled by crimping a circumferential margin of the groove portion at a few points.

In this connection, coupling of the second spring portion can be carried out by crimping the circumferential margin of the groove portion at a few points, however, as shown in FIG. 3(c), by bending the lower end of the second spring portion 4 at an almost right angle, fixedly fitting after inserting the same through a hole pierced in an outside wall of the groove portion 6, and then crimping the same at a few points, the second spring portion 4 can be more solidly coupled.

Here, the second spring portion does not necessarily have to be coupled by crimping, various methods such as, for example, coupling by adhering and coupling by welding can be considered, and it is preferable to employ an optimal method according to the situation.

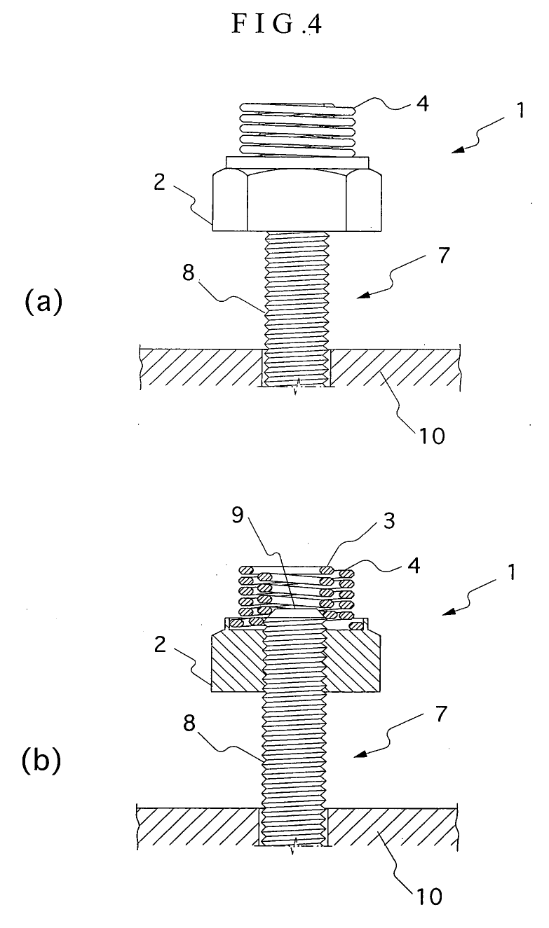

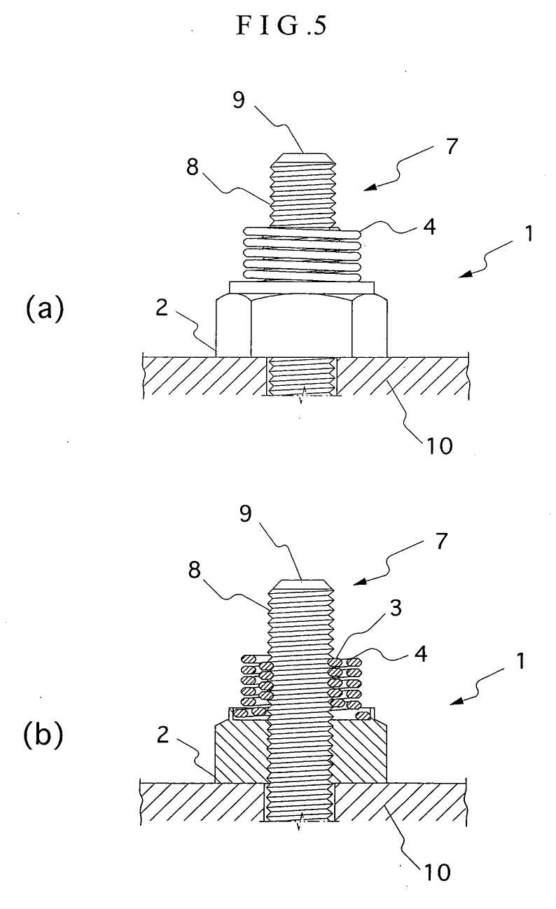

For attachment of the self-locking nut constructed as above to a leg portion of a bolt, as shown in FIGS. 4(a) and (b), by screwing a screw hole 5 at the lower end of the nut body 2 onto a leg portion 8 of a bolt 7 so as to rotate the nut body 2 clockwise, the nut body 2 proceeds while being screwed onto a screw thread of the leg portion 8 of the bolt 7. Then, by further turning the nut body 2 in a condition where a front end portion 9 of the leg portion 8 has entered from the lower end of the first spring portion 3 and has abutted against the inside diameter of the first spring portion 3, the inside diameter of the first spring portion 3 is elastically deformed in a direction to enlarge the inside diameter thereof, so that a strand of the first spring portion 3 is made to fit in along a thread groove of the leg portion 8 from the front end portion 9 of the bolt 7.

Next, as shown in FIGS. 5(a) and (b), fixation of a to-be-fixed object 10 by tightening is carried out by turning the nut body 2 until the lower end face of the nut body 2 abuts against the to-be-fixed object 10 in a condition where the strand of the first spring portion 3 has fitted into the thread groove of the leg portion 8 of the bolt 7.

Here, the strand that fits into the thread groove formed on the leg portion of the bolt slightly floats since the first spring portion is elastically deformed in a direction to enlarge the inside diameter thereof, a frictional force between the first spring portion and leg portion is relieved so as to allow the first spring portion to smoothly fit in, so that it becomes possible to carry out mounting until final tightening even by manual operation.

In addition, since the first spring portion having the inside diameter smaller than the outside diameter of the leg portion of the bolt has been fitted in with the inside diameter thereof enlarged, the strand of the first spring portion is solidly fitted to the leg portion of the bolt by a restoring force of the first spring portion and a frictional force between the first spring portion and leg portion of the bolt, and the strand fitted to the bolt restricts the nut body from rotating in a withdrawal direction.

On the other hand, when the nut body is intended to be turned in a removing direction, since the first spring portion 1 is drawn in a direction to contract the inside diameter thereof, the strand of the first spring portion is more strongly pushed against an inclined surface of the thread groove formed on the leg portion of the bolt so that rotation is prevented.

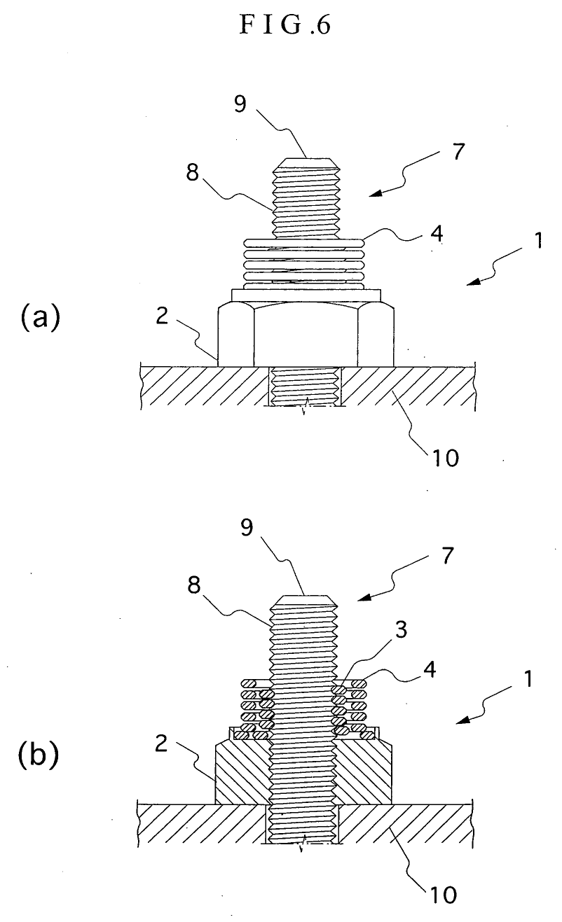

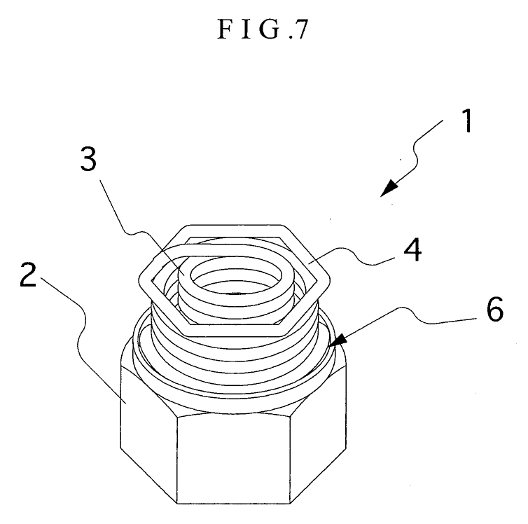

Furthermore, as shown in FIGS. 6(a) and (b), by turning the first spring portion 3 in a tightening direction with the nut body 2 tightened, this is fitted in along the thread groove while being pushed against the upper end of the nut body 2. On the other hand, since the second spring portion 4 has been wound in the opposite direction to that of the first spring portion 3, this is elastically deformed in a direction to contract the inside diameter thereof, and torque in the tightening direction is always given to the first spring portion 3 by a charging force caused by the deformation.

Namely, the nut body receives torque in the tightening direction at all times, and this provides an effect to make it difficult to turn the nut body in the withdrawal direction.

Moreover, FIG. 7 is a schematic perspective view for explaining another example of the self-locking nut to which the present invention has been applied, wherein by winding the upper end portion of the first spring portion 3 into a hexagonal shape, the upper end of the first spring portion 3 is made to be easily grasped, so that rotation in the tightening direction can be easily carried out.

In this connection, the upper end of the first spring portion is formed in a hexagonal shape for the purpose of making the same be easily grasped by a hand, a tool, or the like, and there is not necessarily a need to be wound in a hexagonal shape. Namely, it can be any shape as long as the shape allows easily winding the upper end of the first spring portion in the tightening direction.

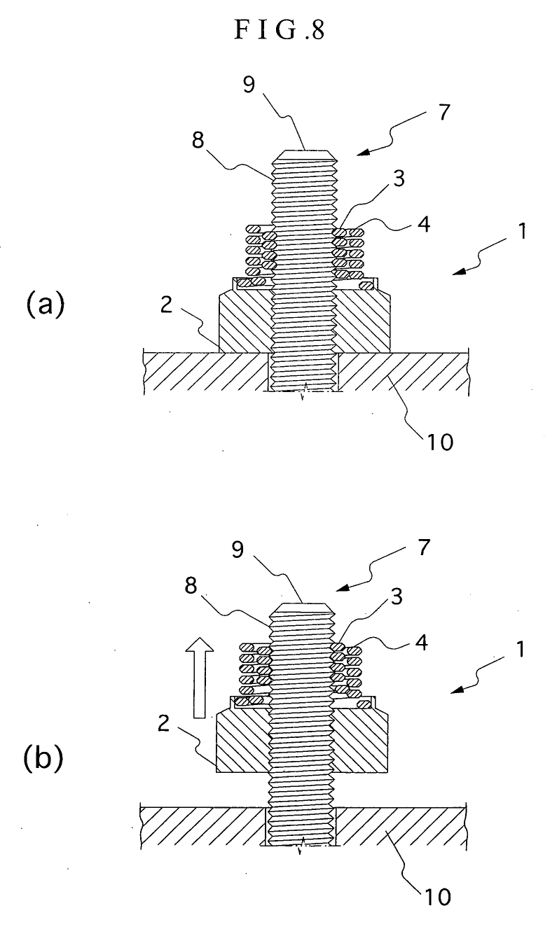

Now, when the self-locking nut is to be removed from the bolt, by rotating the nut body 2 in the withdrawal direction (direction opposite the tightening direction) so as to deform the second spring portion in a direction to contract the diameter, and as shown in FIG. 8(a), supporting by grasping the lower end of the first spring portion 3 by the second spring portion 4 contracted in diameter, and then further rotating the nut body in the withdrawal direction, the self-locking nut is removed in a manner shown in FIG. 8(b).

Here, removal by hand is also possible since a turning force acts on the first spring portion in a direction to enlarge the inside diameter thereof as a result of a turning force being applied thereto in the withdrawal direction with the lower end thereof supported by grasping, however, even when a turning force is applied in the withdrawal direction with the lower end not supported by grasping, rotation is prevented since the first spring portion is drawn by the applied turning force in a direction to contract the inside diameter, so that the self-locking nut cannot be removed.

Consequently, in the example of the self-locking nut to which the present invention has been applied, even when this receives a turning force in the withdrawal direction that acts on the nut owing to an unexpected shock from the outside, tightening by the self-locking nut is never loosened. On the other hand, when the self-locking nut is to be intentionally removed, by forcedly rotating the self-locking nut in the withdrawal direction by hand or a multi-purpose tool, supporting by grasping the lower end of the first spring portion by the second spring portion, and applying a turning force in the withdrawal direction while supporting by grasping the lower end of the first spring portion, the first spring portion is elastically deformed in a direction to enlarge the inside diameter thereof and the strand that fits into the thread groove formed on the leg portion of the bolt therefore slightly floats, and a frictional force between the first spring portion and thread groove formed on the leg portion of the bolt is relieved so as to make it possible to smoothly remove the self-locking nut.

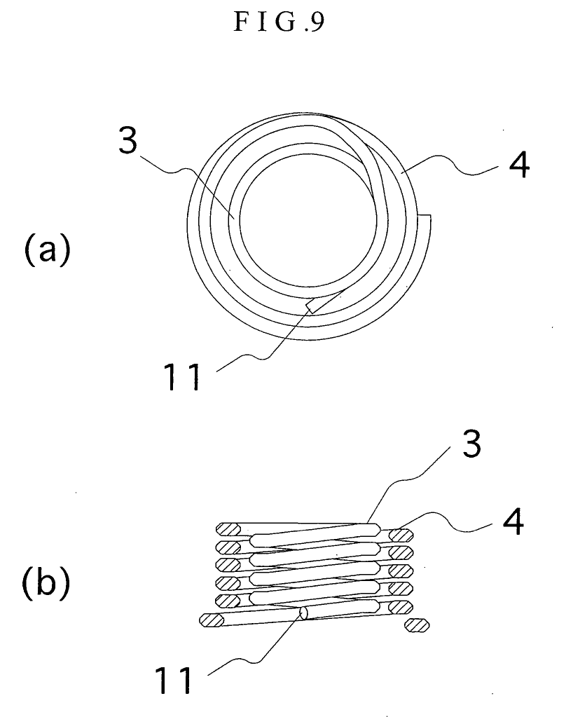

Moreover, the lower end of the first spring portion shown in the example of the self-locking nut to which the present invention has been applied is wound with an inside diameter greater than the outside diameter of the leg portion of the bolt for the purpose of supporting by grasping the lower end of the first spring portion by taking advantage of contraction in diameter of the second spring portion, any latching means can be used as long as it can latch only the lower end, and as shown in, for example, FIGS. 9(a) and (b), it may be provided as a mechanism for which a latching piece 11 is formed by bending the lower end of the first spring portion 3 in the circumferential direction and the first spring portion 3 is rotated so as to push out the same in the withdrawal direction while the second spring portion 4 is latched with the front end of the latching piece 11 as a result of contraction in diameter.

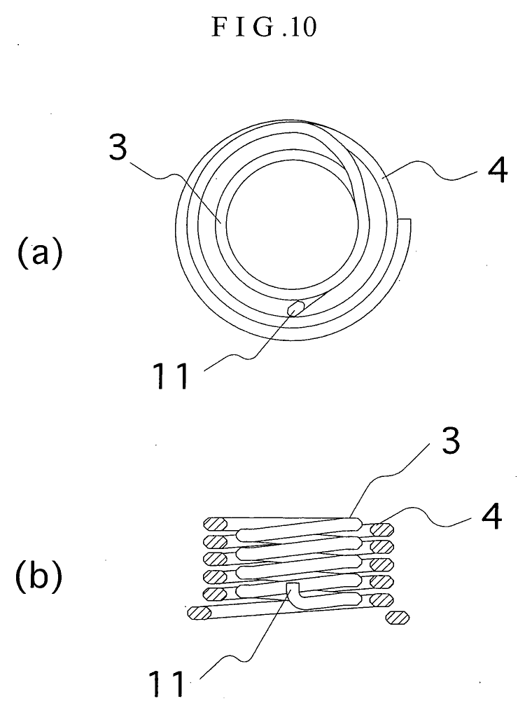

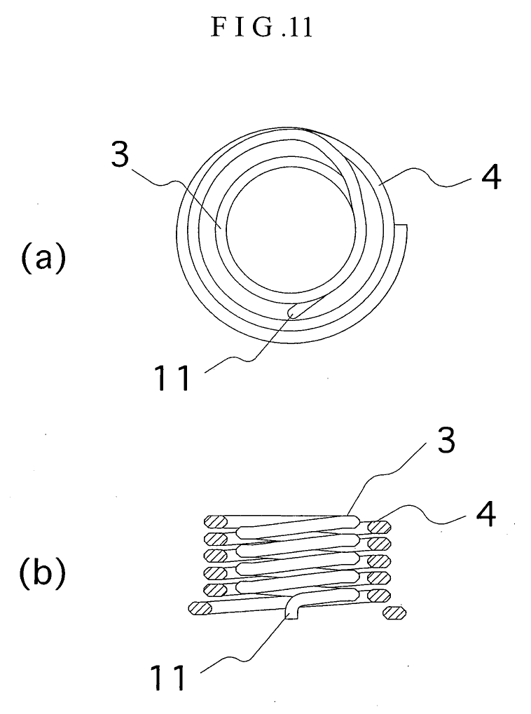

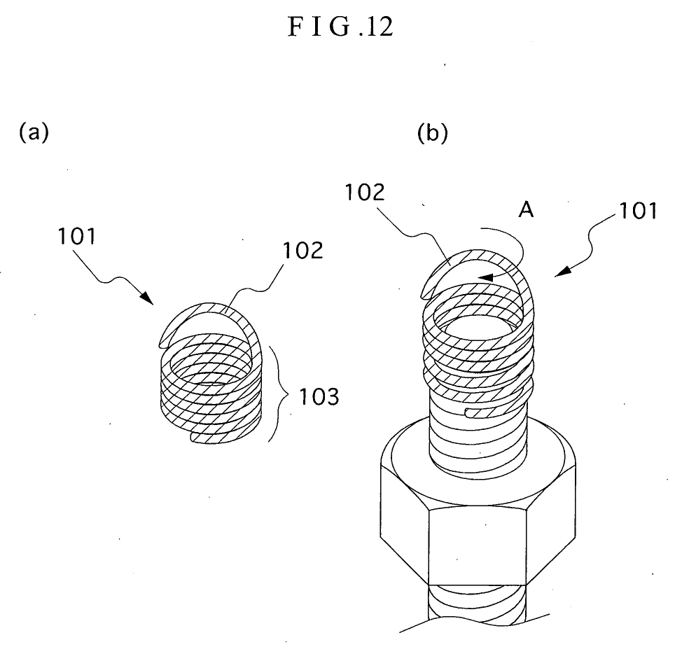

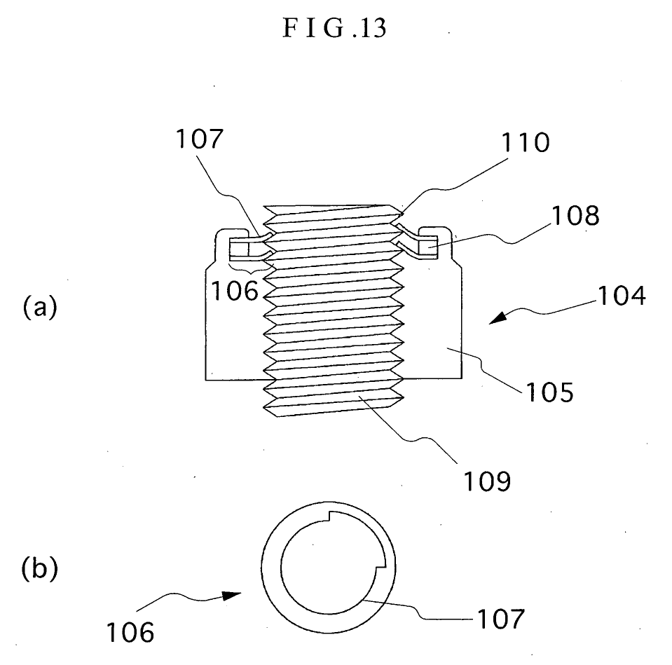

Moreover, as shown in FIGS. 10(a) and (b), by forming a latching piece 11 by bending the lower end of the first spring portion 3 in the circumferential direction and further bending the front end thereof at a right angle in the upper direction, a construction for which the strand of the second spring portion 4 is easily latched with the latching piece 11 by contraction in diameter may be provided. Furthermore, as shown in FIGS. 11(a) and (b), by forming a latching piece 11 by bending the lower end of the first spring portion 3 in the circumferential direction and further bending the front end thereof at a right angle in the lower direction, a construction for which the strand of the second spring portion 4 is easily latched with the latching piece 11 similarly to the construction shown in FIGS. 10 may be provided.

In this connection, with regard to the self-locking nut to which the present invention has been applied, although a description has been given in detail for a case in only the clockwise direction, some nuts are threaded in the counterclockwise direction, and in this case, the first spring portion is wound counterclockwise, and the second spring portion is wound clockwise.

### INDUSTRIAL APPLICABILITY

By the self-locking nut according to the present invention, loosening of the nut after tightening can be reliably prevented, and an excellent effect is provided for tightening of a steel bridge, a steel tower, and the like always shocked by vibration or the like.

In addition, when the nut is to be removed for the reason such as dismantling of the to-be-fixed object, it becomes possible to smoothly withdraw the first spring portion by applying a turning force with a tool so as to latch the lower end of the first spring portion with the second spring portion and then further applying a turning force.

Furthermore, since the self-locking nut according to the present invention never plastically deforms the first spring portion and the second spring portion in the course of attachment and removal with respect to a bolt, it becomes possible to reuse the bolt and nut.

What is claimed is:

1. A self-locking nut comprising:
a first spring portion;
a second spring portion provided in an extended manner continuously from the first spring portion and arranged outside the first spring portion; and
a nut body to whose upper end marginal portion the second spring portion is fixed,
the self-locking nut to be screwed onto a bolt, wherein
the first spring portion is provided with a fitting portion that has an inside diameter smaller than an outside diameter of a leg portion of the bolt and is fitted with a thread groove formed on the leg portion of the bolt and
a latching portion that is provided in an extended manner continuously from a lower end portion of the fitting portion and is protruded from a circumscribed circle of the leg portion of the bolt, and
the second spring portion is constructed so as to be latched with the latching portion when the nut body is rotated in a withdrawal direction at a turning force equal to or more than a predetermined force.

2. The self-locking nut according to claim 1, wherein
the first spring portion and the second spring portion are wound in opposite directions.

3. The self-locking nut according to claim 1 or claim 2, wherein
the latching portion is in a shape of a coil spring wound with an inside diameter greater than the outside diameter of the leg portion of the bolt.
